(19) United States
(12) Patent Application Publication
(10) Pub. No.: US 2008/0085382 A1
(43) Pub. Date: Apr. 10, 2008

(54) Landscape Fabric

(75) Inventors: Jody ERICKSON, Morrisville, NC (US); Terezie ZAPLETALOVA, Raleigh, NC (US); Jeff STINE, Wake Forest, NC (US)

Correspondence Address: FREUDENBERG NONWOVENS L. P., 3440 INDUSTRIAL DRIVE, DURHAM, NC, 27704, US

(73) Assignee: FREUDENBERG NONWOVENS, L.P., Durham, NC (US)

(21) Appl. No.: 11/539,566

(22) Filed: Oct. 6, 2006

(51) Int. Cl. B44F 7/00; G03G 5/00

(52) U.S. Cl. 428/15; 250/316.1

(57) ABSTRACT

The present invention relates to a landscape fabric comprising a nonwoven web wherein the web is configured in a pattern wherein the pattern is derived from an optical representation of an earth covering material, such as bark mulch or nuggets, crushed stone, wood chips, gravel, pebbles, grass, leaves, and sand. The landscape fabric may be formed from spunbond or staple fibers or mixtures thereof.

### FIELD OF THE INVENTION

The present invention relates to a landscaping/erosion control fabric material which may be sourced from a nonwoven fabric that may undergo a thermal-mechanical process, such as embossing. The fabric may then be made to resemble the appearance of earth-covering materials, such as bark mulch or nuggets, pine needles, stone, wood chips, gravel, pebbles, grass, leaves, and sand.

### BACKGROUND OF THE INVENTION

Landscape fabric is commonly used today to control the growth of weeds as well as to resist erosion (surface stabilization) of earth on sloped surfaces. Erosion may occur due to wind or water movement across the surface of the ground. Landscape fabric may also reinforce areas such as flower and shrub beds or trees (tree wells), or may be used on retaining walls and steep slopes, etc. for retention. Landscape fabric may also be used to deter the growth of weeds and grass, to allow selective growth by its absence and to reduce lawn maintenance. The fabric may block out or allow the passage of air, water and sunlight depending on the construction of the fabric and the purpose for which it is used. Landscape fabric by itself, without an overlying layer of mulch, etc., has not found widespread use perhaps because the appearance may not be felt to be aesthetically acceptable in yards, etc.

### SUMMARY OF THE INVENTION

The present invention relates to a landscape fabric comprising polymeric fibers formed into a nonwoven web wherein the web may be embossed in a pattern wherein the pattern may be derived from an optical representation of an earth covering material. In process form the present invention relates to a method of forming a landscape fabric. The method includes the steps of providing a non-woven web and providing an optical representation of a desired appearance of a layer of earth-covering material. This may then be followed by transferring such optical representation into a three dimensional pattern in an image transferring surface (e.g. a roller) and forming said web into said pattern.

### DETAILED DESCRIPTION OF THE INVENTION

The present invention is described more fully hereinafter in which preferred embodiments of the invention are detailed. This invention, may, however, be embodied in many different forms and should not be construed as limited to the embodiments set forth herein; rather, these embodiments are provided so that this disclosure will be thorough and complete, and will fully convey the scope of the invention to those skilled in the art.

In a first exemplary embodiment, a landscape fabric is disclosed which may be sourced from a nonwoven web of polymeric material which has been embossed to provide a desired appearance. The web may also allow penetration by water and air but not allow the growth of grass, weeds, etc. when an appropriate soil preparation is applied prior to use of the fabric. The fabric may be pigmented or tinted to a selected color and in a variety of shades or even a mottled or variegated appearance. The fabric may comprise a spun-bond web wherein the spun-bond web may contain continuous filaments that may have been extruded, drawn and laid on a moving screen. The landscape fabric may also be formed from staple fibers.

Furthermore, the landscape fabric may comprise a combination of a spunbond web utilizing continuous filaments with a staple fiber web, using cut fibers that are either natural or synthetic. Exemplary natural fibers may include wool, cotton, choir, jute, etc. In addition, the landscape fabric may be formed from a layer of a spunbond web along with a layer of staple fibers.

The landscape fabric may be specifically embossed with a three-dimensional pattern to resemble a landscaping type surface. Such landscaping type surface may include earth-covering materials such as bark mulch or nuggets, pine needles, stone, wood chips, gravel, pebbles, grass, leaves, and sand, and mixtures thereof. The three-dimensional pattern may be developed in the fabric by initially transferring an image from a photograph to form a replicated pattern in the surface of embossing roll(s). The image may also be a drawn image and the present invention therefore contemplates any image of a surface to be replicated. The fabric may comprise a web of spun-bonded thermoplastic fibers having a basis weight of about 20 grams per square meter to about 500 grams per square meter, including all values and increments therein. The fibers making up the web may also have a denier in the range of about 1 to about 20, including all values and increments therein. In addition, the fibers in the web may be sourced from fibers that have different denier values within the range of 1-20. Preferably the web may have a denier of about 8-10 grams per 9000 meters. The web may therefore comprise fiber types such as polyester (e.g. polyethylene terephthalate or PET), polyamide, polyolefins (polyethylene and/or polypropylene) including blends, alloys and combinations thereof. Further, the use of bicomponent and/or tricomponent fibers is contemplated, of a variety of constructions, including sheath/core, islands-in-the-sea, etc., alone or in combination with homofibers.

The web may also comprise more than one type of fiber, for instance, fibers differing in polymer type, or differing in melting point, or even differing in color. The use of fibers having different melting points may allow selective thermal bonding of the web (i.e. thermal bonding at one desired temperature at selected locations in the web). The use of different colored fibers may provide the ability to also control appearance. For instance, fibers of different shades of brown when spun-bonded together may, especially when combined with a three-dimensional embossed surface, closely resemble in appearance a layer of bark mulch.

The web, or fibers making up the web, or landscape fabric formed from the web, may also be treated to improve the ultraviolet light resistance/stability. This may be carried out after the web is formed by dipping, spraying, etc. with an ultraviolet absorbing material such as a hindered amine light stabilizer, hindered phenols, etc. The base polymer making up the individual fibers may also be compounded to include such ultraviolet stabilizer at a concentration of less than or equal to about 5.0% by weight (wt).

Once the fibers have been spun-bonded into a web, or otherwise formed into a nonwoven fabric (for instance, using staple fibers to form a web or fabric and combining that layer with a spun-bonded web to form a fabric) the web or fabric may undergo embossment to form an outer surface and appearance that may resemble a landscape material. The web or fabric may be passed between one or more heated and textured rollers which may impart the landscape pattern to the web or fabric. For embossing, it may be appreciated that the web or fabric may be heated to a temperature above its glass transition point (Tg) or above its melting point or Tm. It may also be heated at a temperature between Tg and Tm. In the case of a polyester type resin (e.g. PET) the embossment may take place at a temperature of at or above about 140° C. Accordingly, the rollers employed to emboss may be set at such temperatures or at temperatures above Tg and/or Tm to ensure that the web of material experiences that particular temperature suitable to deform and develop an embossed pattern upon cooling.

The embossed rolls may have the subject pattern imparted to the surface by first providing some sort of optical representation of a desired appearance of a layer of earth covering material. As alluded to above, this may be achieved by providing a photograph or even a drawn image of the earth covering material to be replicated. This may then be followed by chemical etching or laser machining a corresponding pattern which has been generated from such optical representation. This may therefore include forming a digital image of a given pattern, such as the pattern provided by a layer of bark mulch. By using photo-mechanical reproduction, photolithography, holographic or digital file reproduction, the surface of the embossing roll may be chemically etched or laser machined to assume a given three-dimensional pattern which is generally a mirror image of the desired appearance. Thus, when formed over the roll and exposed to the temperatures and/or pressures noted above, the web may be imparted with a substantial replication of the desired landscape image.

It may also be appreciated that with respect to replication of a three-dimensional image herein, it is also contemplated that the actual depth of a given replicated surface may be adjusted as the replicated surface is embossed onto a given web of material. For example, the actual depth of any given feature amongst a plurality of features in an earth covering material having a depth may be reduced by a given factor of between 1-99% including all values and increments therein from what may have existed in the original pattern. In addition, one may determine the average depth of a plurality of features within a given image of an earth covering material and similarly reduce the average depth again by a factor of 1-99%, including all values and increments therein. For example, for a given image of bark mulch, the embossed pattern herein may be reduced in depth from the average depth of such bark mulch pattern to a level of about 50%. In this fashion, the image of bark mulch is generally preserved, and a three-dimensional appearance still exists, but a much lower relative depth profile may be employed in the embossed web than what may have existed in the actual bark mulch image.

The embossing may take place between male and female patterned metal rolls which are geared to coact or between a first roll having a first hardness and a second roll having a second hardness, wherein the second hardness is less than the first hardness. For example, the use of a metal embossed roll and a relatively softer roll sourced from polymeric type material, such as a thermoplastic or thermoset materials. More specifically, one comprised of silicone, urethane, rubber or even natural fibers.

In a second exemplary embodiment, the landscape fabric may comprise three dimensional fiber networks which may be formed by pin chains or pin rollers as disclosed in U.S. application Publication Ser. No. 11/264,389, commonly assigned to the assignee of the present invention and included herein in its entirety by reference. These networks may generally be made by continuously deforming a textile structure into a desired shape at a temperature high enough that the fibers, for example, can be permanently deformed into a rigid three-dimensional shaped network. The deformation may be brought about using a thermo-mechanical process, which means that mechanical force may be applied at elevated temperatures less than and ranging up to 300° C. and any value or range therebetween including 100° C., 200° C., etc. The mechanical force may be applied through the interdigitation of projections (pins or bars) and corresponding depressions from, e.g., pin chains or rollers to form a texture. Heat and pressure may be applied for a sufficient period of time such that the fabric is permanently deformed, but not for such a length of time or at such an increased temperature that the filaments coalesce, causing the shaped fiber network, for example, to substantially lose its resilience.

The landscape fabric of the present invention having an embossed texture resembling a layer of bark mulch may be used in gardens, tree wells, etc. by attachment to the ground with anchoring pins or by burying the edge of the fabric in an at least partially surrounding trench. The bark mulch that may be replicated herein includes, e.g., hardwood mulch, hemlock mulch, spruce mulch, pine bark mulch, cocoa shell mulch, aged mulch and/or dyed cedar. Plants or fruit-bearing crops may also be used to retain the edges of the fabric in place. It may therefore appreciated that the landscape fabric of the present invention, as compared to ordinary mulch, provides a number of advantages, such as avoiding the need to spread, the fabric does not “float away”, it provides a relatively rich long-lasting color, minimizes dust, is non-toxic, resists significant fading and compaction, does not attract termites and other insects and is relatively clean (i.e., it does not tend to decompose or absorb significant quantities of water).

The present invention also may provide a landscape fabric which may be tailored to provide the level of opaqueness and permeability desired, and which may assume the external appearance of an overlying layer of mulch or other earth-covering material. The present invention also may provide a structure which may allow water and air to pass through yet prevent weed growth and therefore provide a unique balance in both appearance and functional features.

The description illustratively sets forth the presently preferred invention embodiment. We intend the description to describe this embodiment and not to limit the scope of the invention. Obviously, it is possible to modify these embodiments while remaining within the scope of the following claims. Therefore, within the scope of the claims one may practice the invention otherwise than as the description and drawings specifically show and describe.

What is claimed is:

1. A method for forming a landscape fabric comprising the steps of:
providing a non-woven web;
providing an optical representation of a desired appearance of a layer of earth-covering material;
transferring said optical representation into a three dimensional pattern in the surface of one or more image transferring surfaces; and
forming said web into said pattern.

2. The method of claim 1 wherein said image transferring surface comprises a roller.

3. The method of claim 1 wherein said web comprises polyester, polyamide and polyolefin fibers and blends, alloys or combinations thereof.

4. The method of claim 1 wherein said web comprises homocomponent fibers, bicomponent fibers, tricomponent fibers or combinations thereof.

5. The method of claim 1 wherein said web has a basis weight between about 20 to 500 grams/square meter.

6. The method of claim 1 wherein said web comprises fibers having a denier of about 1-20.

7. The method of claim 1 wherein said transferring comprises any one of photo-mechanical reproduction, photolithography, holographic or digital file reproduction.

8. The method of claim 1 wherein said representation comprises an etching mask.

9. The method of claim 2 wherein said three dimensional pattern in the surface of said roller is formed by machining with a laser.

10. The method of claim 2 wherein said three dimensional pattern in the surface of said roller is formed by chemical etching.

11. The method of claim 1 wherein said layer of earth-covering material is selected from the group consisting of bark mulch or nuggets, pine needles, stone, wood chips, gravel, pebbles, grass, leaves, sand and mixtures thereof.

12. The method of claim 1 wherein said forming of said pattern comprises embossing said pattern into said web.

13. The method of claim 12 wherein said embossing is done with male/female embossing rolls.

14. The method of claim 12 wherein said embossing is done with an embossed metal roll having a first hardness and a second roll having a second hardness that is lower than said first hardness.

15. The method of claim 14 wherein said second roll comprises one of silicone, urethane, rubber or natural fibers.

16. The method of claim 1 wherein said forming of said pattern comprises deforming said web with one or a plurality of projections.

17. The method of claim 1 wherein said step of providing said optical representation comprising a three dimensional pattern in the surface of one or more image transferring surfaces further comprises:
determining an average depth of said layer of earth covering material and said optical representation of said three dimensional pattern is set with an average depth that is 1-99% of said earth covering material average depth.

18. The method of claim 1 wherein the web comprises fibers that have different denier values, said values falling in the range of about 1-20.

19. A landscape fabric comprising a non-woven web wherein said web is embossed in a pattern wherein said pattern is derived from an optical representation of an earth covering material.

20. The landscape fabric of claim 19 wherein said earth covering material is selected from the group consisting of bark mulch or nuggets, pine needles, stone, wood chips, gravel, pebbles, grass, leaves, sand and mixtures thereof.

21. The landscape fabric of claim 19 wherein said non-woven web comprises a polymer selected from the group consisting of polyester, polyolefin and polyamide, said web having a basis weight of about 20 to about 500 grams/square meter.

22. The landscape fabric of claim 19 wherein said non-woven web comprises continuous filaments or staple fibers.

23. The landscape fabric of claim 22 wherein said staple fibers comprise natural or synthetic fibers.

24. The landscape fabric of claim 19 wherein said non-woven web comprises a layer of continuous filaments and a layer of staple fibers.
